(19) United States
(12) Patent Application Publication
(10) Pub. No.: US 2013/0282352 A1
(43) Pub. Date: Oct. 24, 2013

(54) REAL TIME LOGIC SIMULATION WITHIN A MIXED MODE SIMULATION NETWORK

(71) Applicant: GRAYSKYTECH LLC, Woodinville, WA (US)

(72) Inventors: JERROLD L. GRAY, WOODINVILLE, WA (US); JASON M. SMITH, REDMOND, WA (US)

(21) Appl. No.: 13/921,832

(22) Filed: Jun. 19, 2013

Related U.S. Application Data
(63) Continuation-in-part of application No. 13/851,859, filed on Mar. 27, 2013.
Application No. 13/851,859 is a continuation-in-part of application No. 13/476,000, filed on May 20, 2012.
(60) Provisional application No. 61/662,243, filed on Jun. 20, 2012.
(60) Provisional application No. 61/488,540, filed on May 20, 2011.

(51) Int. Cl. G06F 17/50

(52) U.S. Cl. CPC G06F 17/5036
USPC 703/15

(57) ABSTRACT

Technologies relating to real time logic simulation within a mixed mode simulation network are described. Mixed mode simulation networks may comprise Boolean Processing Units (BPUs) and Real Time Processing Units (RTPUs). Mixed mode simulation networks may send an input simulation state vector to the processing units, and the processing units may process portions thereof to calculate portions of an output simulation state vector. BPUs may be adapted to calculate portions of the output simulation state vector without accounting for delay times attributable to operation of a simulated system, while RTPUs may be adapted to calculate portions of the output simulation state vector with accounting for delay times attributable to operation of the simulated system. The calculated portions of the output simulation state vector may be combined in a computational memory, and the resulting output simulation state vector may be used as an input simulation state vector in a next simulation calculation cycle.

### CROSS REFERENCE TO RELATED APPLICATIONS

This is a continuation in part of U.S. patent application Ser. No. 13/476,000, filed May 20, 2012, entitled “MACHINE TRANSPORT AND EXECUTION OF LOGIC SIMULATION”, which is a non-provisional of U.S. Provisional Application No. 61/488,540, filed May 20, 2011, entitled “MACHINE TRANSPORT AND EXECUTION OF LOGIC SIMULATION”. This is also a non-provisional of U.S. Provisional Patent Application 61/662,243, filed Jun. 20, 2012, entitled “ARCHITECTURE FOR EFFICIENT REAL TIME LOGIC SIMULATION WITHIN A MIXED MODE SIMULATION NETWORK”. The prior applications are incorporated by reference.

### BACKGROUND

This disclosure relates to the field of model simulation and more specifically to methods of data distribution and distributed execution that enable the design and execution of superior machines used in logic simulation.

Most logic simulation is performed on conventional Central Processing Unit (CPU) based computers ranging in size and power from simple desktop computers to massively parallel super computers. These machines are typically designed for general purposes and contain little or no optimizations that specifically benefit logic simulation.

Many computing systems, including Digital Signal Processors (DSPs) and embedded micro controllers, are based on a complex machine language (assembly and/or microcode) with a large instruction set commensurate with the need to support general-purpose applications. These large instruction sets reflect the general-purpose need for complex addressing mode, multiple data types, complex test-and-branch, interrupt handling and use of various on-chip resources. DSPs and CPUs provide generic processors that are specialized with software which may take the form of high-level software, assembly-level software, or microcode.

There have been previous attempts to create faster processing for specific types of data, for example the Logic Processing Unit (LPU). The LPU is a small Boolean instruction set with logic variables based on 2-bit representations (0, 1, undefined, tri-state). However, there were processing shortcomings in the LPU because it is still a sequential machine performing one instruction at a time and on one bit of logic at a time.

More specific types of numerical processing, for example logic simulation, have utilized unique hardware to achieve performance in specific analysis. While this is effective for processing or acting on a given set of data in a time efficient manner, it does not provide the scalability required for the very large models needed today and even larger in the future.

Another shortcoming of current computing systems is the lack of machine optimizations of Boolean logic within the general CPUs. The combined lack of specialized CPU instructions and a desire to off-load CPU processing has led to an explosion of graphics card designs over the years. Many of these graphics cards have been deployed as vector co-processors on non-graphic applications merely due to the nature of the types of data and graphic card machine processing being similar.

Data types defined by IEEE standards for logic are based on an 8-bit representation for both logic nodes and storage within VHSIC Hardware Description Language (VHDL), Verilog, as well as other Hardware Description Languages (HDLs). Many simulation systems have means of optimizing logic from 2 to 4 bits to make storage and transport more efficient. Yet, CPUs cannot directly manipulate these representations because they are not “native” to the CPU and they have to be calculated with high or low level code.

Logic synthesis tools from various tool providers have demonstrated that arbitrary logic can be represented by very small amounts of data. This is evidenced by the fact that tools can successfully target families of Field Programmable Gate Arrays (FPGAs) and Application Specific Integrated Circuits (ASICs), which are based on very simple logic primitives.

HDL compilers often generate behavior models for simulation and logic structures for synthesis. Simulation behavior models are a part of the application layer which is built from some high level language which is independent of machine form, but whose throughput is dependent on the CPU machine, the machine language, and the operating system.

Logic simulation across multiple Personal Computer (PC) platforms is not practical and current simulation software cannot take advantage of multiple core CPUs. In multiple core CPUs, the individual cores support very large instruction sets and very large addressing modes. Although the individual cores share some resources, they are designed to work independently. Each core consumes an enormous amount of silicon area per chip so that CPUs found in common off-the-shelf PCs may contain only 2 to 8 cores.

Chips that contain over eight cores (for example, the Rapport chip, which currently has the largest number of cores with 256 processors), are more or less designated for embedded applications or functions peripheral to a CPU. These individual cores are still rather complex general-purpose processors on the scale of 8-bit and 16-bit processors in the early days of the first microprocessors (8008, 8085, 8086, etc.) with smaller address space.

### SUMMARY

The present disclosure generally describes technologies including devices, methods, and computer readable media relating to real time logic simulation within a mixed mode simulation network. Example mixed mode simulation networks may comprise Boolean Processing Units (BPUs) and Real Time Processing Units (RTPUs). Example mixed mode simulation networks may comprise a computational memory configured to store simulation state vectors; a data bus coupled with the computational memory; a data stream controller coupled with the data bus; and an array of processing units coupled with the data stream controller, the array of processing units comprising BPUs and RTPUs.

Mixed mode simulation networks may be adapted to send input simulation state vectors from the computational memory, through the data bus and data stream controller, to the array of processing units. Each processing unit in the array may be adapted to process a portion of an input simulation state vector to calculate a portion of an output simulation state vector. The BPUs may be adapted to calculate portions of the output simulation state vector without accounting for delay times attributable to operation of a simulated system. The RTPUs may be adapted to calculate portions of the output simulation state vector with accounting for delay times attributable to operation of the simulated system. The mixed mode simulation network may be adapted to return calculated portions of the output simulation state vector from the array of processing units through the data stream controller and data bus, and to combine the calculated portions of the output simulation state vector in the computational memory.

Example RTPUs adapted for use in a simulation network may include a read/write module adapted to read input simulation state vectors for processing by the RTPU, and to write RTPU output simulation state vectors; a memory component adapted to store input simulation state vectors for processing by the RTPU as well as a Logic Expression Table (LET) and a delay table, and an execution unit. The execution unit may comprise a Product Term Latching Comparator (PTLC) adapted to calculate next simulation state vectors from input simulation state vectors and the LET, and a Real Time Look Up (RTLU) engine adapted to look up, in the delay table, delay times associated with transitions from components of input simulation state vectors to corresponding components of next simulation state vectors. The RTPU may be adapted calculate output simulation state vectors as next simulation state vectors minus transitions having delay times that exceed a clock cycle of a simulated system.

Example methods for real-time simulation by RTPUs in a simulation network may comprise reading an input simulation state vector for processing by a RTPU; storing the input simulation state vector in a memory for processing by the RTPU; calculating a next simulation state vector from the input simulation state vector; looking up delay times associated with transitions from components of the input simulation state vector to corresponding components of the next simulation state vector; calculating an output simulation state vector as the next simulation state vector minus transitions having delay times that exceed a clock cycle of a simulated system; and writing the output simulation state vector to a simulation network bus for combination with one or more other simulation state vectors. The simulation network may combine the output simulation state vector with output simulation state vectors from a network of mixed BPUs and RTPUs, which output simulation state vectors may comprise, e.g., Boolean Compatible Format (BCF) vectors and/or Real Time Format (RTF) vectors.

Other features, objects and advantages of this disclosure will become apparent from the following description, taken in connection with the accompanying drawings, wherein example embodiments of the invention are disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram illustrating an example computing system with a simulation engine.

FIG. 2 is a block diagram illustrating an example simulation network.

FIG. 3 is a block diagram illustrating an example RTPU and its integration with a simulation network.

FIG. 4 includes a set of tables illustrating an example LET used to define synthesized logic models for simulation.

FIG. 5 is a block diagram illustrating example components of a PTLC and interactions thereof

FIG. 6 is a block diagram illustrating example components of a RTLU and interactions thereof

FIG. 7 is a diagram illustrating example distributed delays in real time computation, and treating distributed delays as a “lumped” delay.

FIG. 8 is a flow diagram illustrating an example method configured to simulate a logic cycle from a host software perspective.

FIG. 9 is a pie chart of an example mixed mode model.

### DETAILED DESCRIPTION

Detailed descriptions of preferred embodiments are provided herein. It is to be understood, however, that the present disclosure may be embodied in various forms. Therefore, specific details disclosed herein are not to be interpreted as limiting, but rather as a basis for the claims and as a representative basis for teaching one skilled in the art to employ the teachings herein in virtually any appropriately detailed system, structure or manner.

Technologies relating to real time logic simulation within a mixed mode simulation network are described. In general, mixed mode simulation networks may comprise BPUs and RTPUs. Mixed mode simulation networks may send an input simulation state vector to the processing units, and the processing units may process portions thereof to calculate portions of an output simulation state vector. BPUs may be adapted to calculate portions of the output simulation state vector without accounting for delay times attributable to operation of a simulated system, while RTPUs may be adapted to calculate portions of the output simulation state vector with accounting for delay times attributable to operation of the simulated system. The calculated portions of the output simulation state vector may be combined in a computational memory, and the resulting output simulation state vector may be used as an input simulation state vector in a next simulation calculation cycle.

An example simulated system may comprise, e.g., a computer processor that is in the design stage, e.g., processors such as those made by INTEL® and AMD®. Processors are highly complex, and it is expensive to configure equipment to manufacture a processor, or in some cases, to manufacture a great many processors. Therefore, it is desirable to simulate performance of processors prior to actually manufacturing them. Techniques described herein may be used to simulate processors, and disclosed techniques may also be applied in other contexts as will be appreciated.

Very generally, simulation according to this disclosure may comprise representing a state of a simulated system with a simulation state vector. The simulation state vector may be stored in a computational memory. Simulation may proceed by using a first simulation state vector to calculate a subsequent simulation state vector, using the subsequent simulation state vector to calculate another subsequent simulation state vector, and so on, repeatedly, as necessary to perform the simulation. In other words, an “input simulation state vector” may be used to calculate an “output simulation state vector”, and the output simulation state vector may be used as a next input simulation state vector, in a repeating cycle of state vector calculations.

In some embodiments, state vector calculations may be accomplished by a plurality of processing units, where each processing unit is responsible for a portion of an input simulation state vector. Each processing unit may process its portion of an input simulation state vector, and produce a corresponding portion of an output simulation state vector. The calculated portions of the output simulation state vector may be combined into an output simulation state vector.

This disclosure appreciates that some aspects of simulation may be accomplished effectively without accounting for delay times attributable to operation of a simulated system, while other aspects of simulation may be accomplished more effectively with accounting for delay times attributable to operation of the simulated system. For example, a simulated processor may actually have some real-time delay in transitioning one or more bits from a “0” to a “1”, or transitioning one or more bits from a “1” to a “0”. Such delays may in some cases be enough to affect an output simulation state vector. Therefore, embodiments of this disclosure may include both “delay aware” processing units, an example of which is a RTPU, and “delay blind” processing units, an example of which is a BPU. Portions of an input simulation state vector that are more effectively processed by a delay aware processing unit may be assigned for processing by a RTPU, and portions of input simulation state vector that are more effectively processed by a delay blind processing unit may be assigned for processing by a BPU. Behavior of an example simulation network, including BPUs and RTPUs, is described in detail herein.

Technologies described herein include, inter alia, methods, devices, systems and/or computer readable media deployed therein relating to machine transport and execution of logic simulation. In some examples, logic simulation systems may cyclically calculate logic state vectors based on the current state and inputs into the system. A state vector may comprise a state of a logic storage element in a model. State vectors may be distributed from a core of common memory to one or more arrays of processors to compute a next state vector. The one or more arrays of processors may be connected with data stream controllers and memory for efficiency and speed.

For example, in some embodiments, a computing system may be configured to comprise a simulation system, wherein the simulation system comprises a computational memory, one or more deterministic data buses coupled with the computational memory, multiple data stream controllers coupled with the one or more deterministic data buses, and a plurality of logic processors. The simulation system, which may be referred to as a simulation engine, is a computing engine for simulation.

Simulation can be understood as a cyclic process of calculating the next state of a model based on the current state and inputs to the system. In logic systems the state of a model may be referred to as the “state vector.” The “current state vector” is defined as current state of all the logic storage elements (flip-flops, RAM, etc.) that are present in the model.

Logic simulation can be understood as a “discrete” calculation of logic state vectors, wherein “cycle based” or Boolean calculations are performed without respect to logic propagation delays and “real time” calculations account for logic propagation delays. Combined cycle based and real time calculations in a single simulation are referred to as “mixed mode,” although in some contexts, this term has been extended to include continuous modeling such as found in Simulation Program with Integrated Circuit Emphasis (SPICE).

In some embodiments, computational memory of the simulation engine may be configured to store state vectors. A simulation engine that has state vectors loaded into computational memory may be configured to distribute, by each of the multiple data stream controllers, an input comprising a portion of the state vector for processing by a sub-array of computational logic processors. Each of the multiple data stream controllers may be configured to be coupled with a different sub-array of computational logic processors. In some embodiments, the PTLC within each of the computational logic processors may be configured to process the inputs.

Processing of a primitive portion of the state vector (a single memory element) can be accomplished with a simple set of rules. Bits and words can be processed with a small instruction set on a logic specific processor core much smaller in silicon area than those described above, such that chips built from this technology could contain thousands of processor cores. These Random Access Memory (RAM) based processor cores can be configured with conventional machine language code augmented by RAM based synthetic machine instructions compiled from the user's source code HDL. This enables the core to efficiently emulate one or more pieces of the overall model to a high level of efficiency and speed.

The deterministic nature of simulation allows for the use of deterministic methods of connecting arrays of logic processors and memory. These deterministic methods are usually defined as “buses” rather than “networks” and techniques are generally referred to as “data flow.” These are considered tightly coupled systems of very high throughput.

In some embodiments, physical data flow architectures described herein can be configured to distribute state vectors from a core of common memory to one or more arrays of processors to compute the next state vector, which is returned to the core of common memory.

In some embodiments, the one or more computational logic processors may be configured to comprise a FPGA or an ASIC. In some embodiments, the one or more computational logic processors may be configured to provide modeling of logic constructions. In some embodiments, the one or more computational logic processors may be configured to comprise a BPU, a RTPU, or a logic specific Von Neumann processor. In some embodiments, the RTPU may be configured to perform real-time look-ups to determine timing of logic propagation and transition to simulate behavior of a physical circuit simulated by the logic simulation engine.

In some embodiments, one or more of the computational logic processors may be configured to comprise a BPU or a RTPU coupled with a dual port RAM, and a Vector State Stream (VSS) read/write module coupled with a VSS deterministic data bus, wherein the dual port RAM is configured to store instructions, LETs, and assigned input vectors, and wherein the VSS read/write module is configured to splice large input state vectors into smaller components and to recombine computed output vector data into the deterministic bus. In some embodiments, the VSS read/write module coupled to the RTPU may be configured to comprise a RAM based First-In First-Out (FIFO) configured to sort output vector data based on time of change before the output vector is released to the deterministic bus.

In some embodiments, the simulation engine may be configured to provide a compact “true logic” Sum Of Product (SOP) representation of the logical Boolean formulas relating combinatorial inputs to output in any logic tree. In some embodiments, the simulation engine may be configured to facilitate algorithmically reduced synthesized logic by utilizing a SOP form of logic representation in machine code compatible with the aforementioned logic specific processors. This form and machine operation supports input and output inversions and simultaneous computation of multiple inputs and outputs.

In some embodiments, the simulation engine may be configured to provide efficient notation for positive and negative edge propagation, such that machine code can calculate delays in the combinatorial data path for RTPUs.

The cyclic behavior described herein for state vector data emulates a repetitive “circuit” of data in the same sense that a telephone “circuit” repeats transporting voice signals along the same physical path. Simulation software in the host computer is responsible for definition and set up of these vector paths but need not play a role in the actual transport.

The “little” software intervention cited above is directed at software needed to deal with modular pieces excluded from the main model, and extra non-model features such as breakpoints, exceptions, and synchronization. The significance of this is that as the model grows in size, host management of the overall system grows to set up the system, but does not grow with execution of the system. A clarifying analogy would be to think of the host's responsibilities for a chip simulation is at the chip's pins (pin counts in hundreds) and the modeling covering the internal gates (counts of a few hundred to many millions).

Any combination of data storage devices, including without limitation computer servers, using any combination of programming languages and operating systems that support network connections, is contemplated for use in the present inventive method and system. The logic simulation method and system described herein are also contemplated for use with any communication network, and with any method or technology, which may be used to communicate with said network.

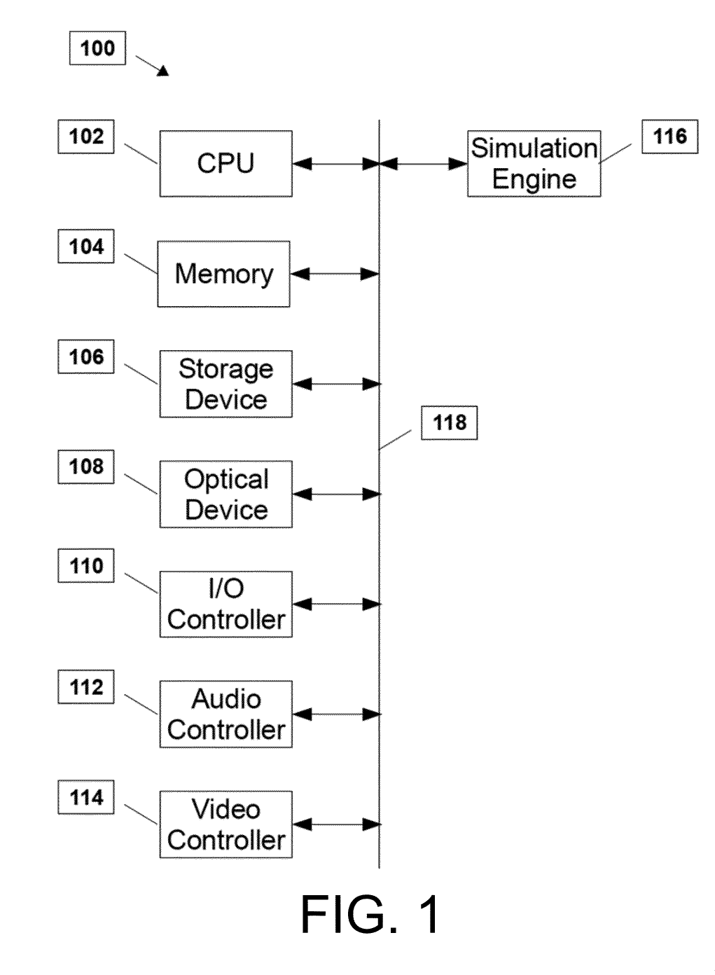

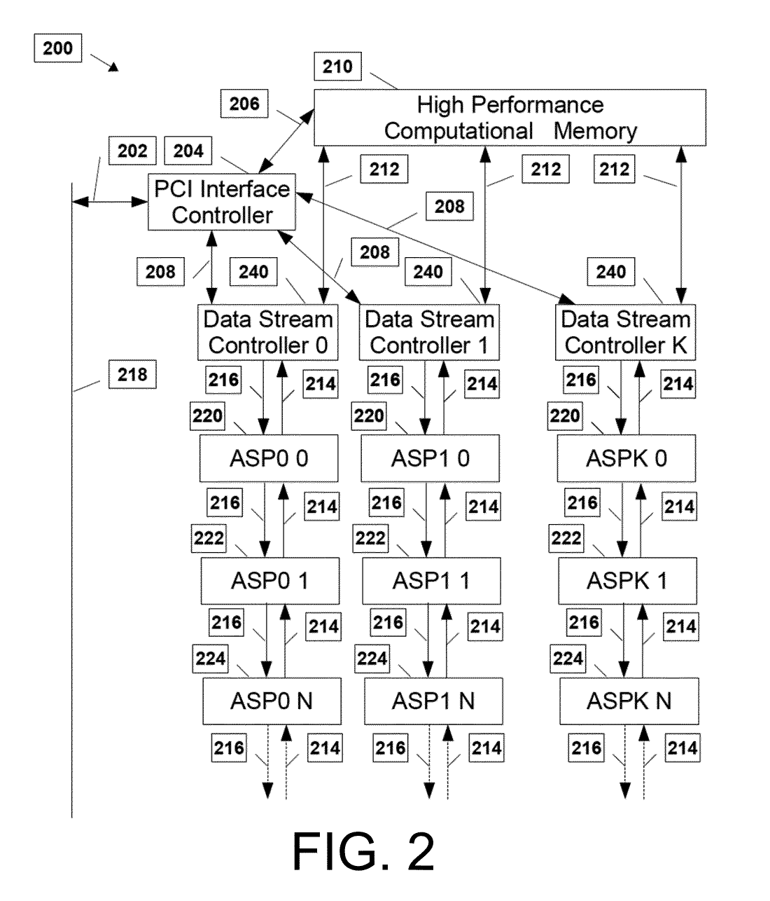

FIG. 1 is a block diagram illustrating an example computing system with a simulation engine, arranged in accordance with at least some embodiments of the present disclosure. FIG. 1 includes a computing device 100. Computing device 100 includes a CPU 102, a memory 104, a storage device 106, an optical device 108, an I/O controller 110, an audio controller 112, a video controller 114, and a simulation engine 116, all sharing a common bus system 118. Simulation engine 116 may implement a simulation network as described with reference to FIG. 2.

In FIG. 1, CPU 102, memory 104, storage device 106, optical device 108, I/O controller 110, audio controller 112, video controller 114, and simulation engine 116 are coupled to bus system 118. The components of computing device 100 may be located on one or more computing devices, e.g., servers which may (or may not) be accessible via virtual or cloud computing services, desktop or laptop type computing devices, or any combination thereof

In FIG. 1, computing device 100 is configured to use simulation engine 116 as part of the overall simulation environment. Software executable by computing device 100, either as a server or a client application, may be referred to herein as host software and may be configured to provide and manage simulation resources to implement simulation techniques described herein. This host software may also support I/O elements of simulation, commonly known as the “test fixture.” CPU 102 may comprise one or more of a standard microprocessor, microcontroller, and/or digital signal processor (DSP). Host software may be stored in memory 104 and/or storage device 106 and may be executable by CPU 102.

In FIG. 1, memory 104 may be implemented in a variety of technologies. Memory 104 may comprise one or more of RAM, Read Only Memory (ROM), and/or a variant standard of RAM. Memory 104 may be configured to provide instructions and data for processing by CPU 102. Memory 104 may also be referred to herein as host memory or common memory.

In FIG. 1, storage device 106 may comprise a hard disk for storage of an operating system, program data, and applications. Optical device 108 may comprise a CD-ROM or DVD-ROM. I/O controller 110 may be configured to support devices such as keyboards and cursor control devices. Audio controller 112 may be configured for output of audio. Video controller 114 may be configured for output of display images and video data. Simulation engine 116 is added to the system through bus system 118.

In FIG. 1, the components of computing device 100 may be coupled together by bus system 118. Bus system 118 may include a data bus, address bus, control bus, power bus, proprietary bus, or other bus. Bus system 118 may be implemented in a variety of standards such as Peripheral Component Interconnect (PCI), PCI Express, or Accelerated Graphics Port (AGP).

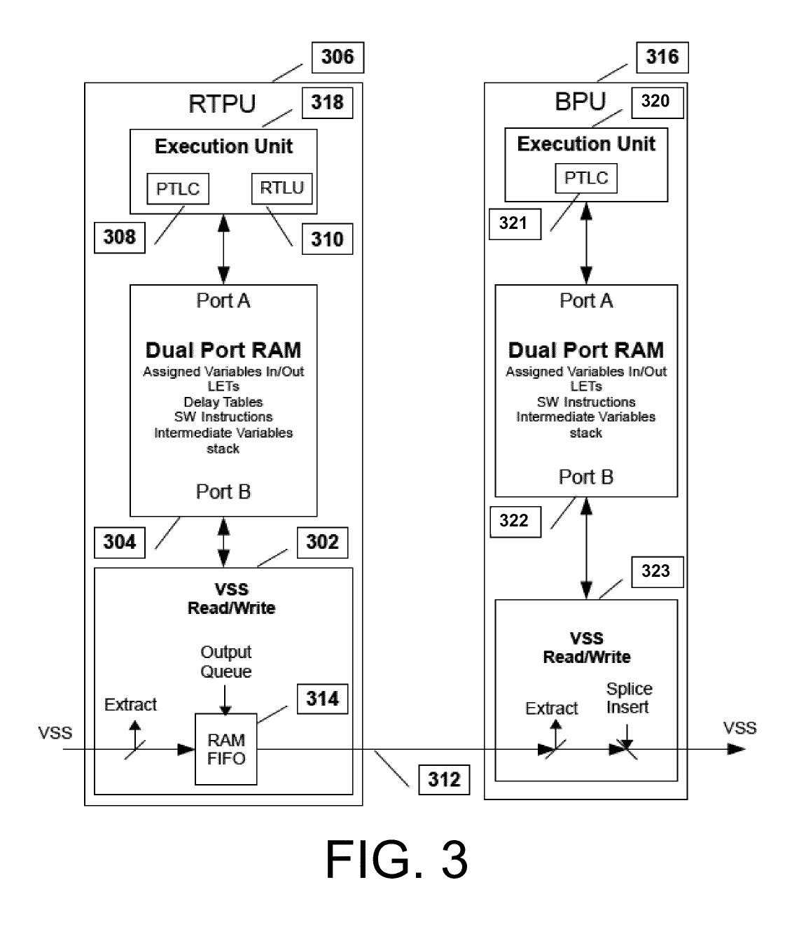

FIG. 2 is a block diagram illustrating an example simulation network, arranged in accordance with at least some embodiments of the present disclosure. FIG. 2 includes a simulation engine 200 comprising a PCI interface controller 204, a high performance computational memory 210, a plurality of Data Stream Controllers (DSCs) 240, including DSC 0, DSC 1, and/or further DSCs up to DSC K. Simulation engine 200 is an example of a simulation network. Each DSC is coupled with a sub-array of computational logic processors. In FIG. 2, the computational logic processors (also referred to herein as processing units) are implemented by Application Specific Processors (ASPs) comprising ASPs 220, ASPs 222, and ASPs 224. Some of the illustrated ASPs may comprise BPUs, and some of the illustrated ASPs may comprise RTPUs, each of which are illustrated in FIG. 3. The sub-array of computational logic processors for DSC 0 may comprise ASP0 0, ASP0 1, and/or further ASPs up to ASP0 N. The sub-array of computational logic processors for DSC 1 may comprise ASP1 0, ASP1 1, and/or further ASPs up to ASP1 N. The sub-array of computational logic processors for DSC K may comprise ASPK 0, ASPK 1, and/or further ASPs up to ASPK N.

PCI interface controller 204 may be coupled to a bus system 218 by an interface 202. Bus system 218 may be identical to bus system 118 in FIG. 1. PCI interface controller 204 may interact with high performance computational memory 210 by transactions 206. PCI interface controller 204 may interact with DSCs 240 by transactions 208. High performance computational memory 210, which may also be referred to herein as computational memory 210, may interact with DSCs 240 by transactions 212. Each DSC 240 may be coupled with an array of ASPs by a bus having an inbound data stream 214 and an outbound data stream 216. Each ASP within a sub-array of ASPs may be coupled to each other in a linear fashion by the bus with inbound data stream 214 and outbound data stream 216. The bus with inbound data stream 214 and outbound data stream 216 may be a VSS bus as shown in FIG. 3.

In some embodiments, PCI bus 202 may comprise PCIe version 1.1, 2.0 or 3.0, or any later developed version. The latter versions are backward compatible with PCIe version 1.1, and all are non-deterministic given they rely on a request/acknowledgement protocol with approximately a 20% overhead. Though some standards versions are capable of 250 MB/s, 500 MB/s, and 1 GB/s respectively, this may be too slow for host memory to act as “common” memory in some embodiments.

Computational memory 210 may be compatible with PCI interface controller 204. Computational memory 210 may comprise, e.g., a 64-bit wide memory. The data width of memory 104 depends on requirements, but is not restricted by PCI interface controller to 64-bit. The same memory can be configured to appear as 64-bit on the host port and 128-bit or 256-bit (or whatever is required) on the DSC 240 ports. With DDR2 (Double Data Rate) and DDR3 SDRAM (Synchronous Dynamic Random Access Memory) memory data transfer rates of 8.5 GB/s and 12.8 GB/s respectively, it is likely that host memory at 64-bit will be able to support more than one DSC 240, and 128-bit or 256-bit wide memory could support many DSCs. Further, simulation engine 200 may use computational memory 210 to service more than one array of processors. Computational memory 210 may be configured to ensure that the ASP array system does not become I/O limited.

Simulation engine 200 may comprise one or more DSCs 240. DSCs 240 may be referred to as DSC0, DSC1 . . . etc., up to “K” number of DSCs, which may be referred to as DSCK. Each of DSCs 240 may be configured to support a sub-array of one or more computational logic processors, such as the illustrated ASPs, where “N” refers to the number(s) of computational logic processors supported by DSCs 240.

In FIG. 2, ASPs 220 may be located one level away from DSC 240s. ASPs 222 may be located two levels away from DSCs 240. ASPs 224 may be located N levels away from DSCs 240, wherein “N” equals the last level of ASP away from DSCs 240. ASPs in an array controlled by DSC0 may be referred to as ASP0 0 for the first level of ASPs, ASP0 1 for the second level of ASPs, and ASP0 N for the Nth level of ASPs. ASPs in an array controlled by DSC1 may be referred to as ASP1 0 for the first level of ASPs, ASP1 1 for the second level of ASPs, and ASP1 N for the Nth level of ASPs. ASPs in an array controlled by DSCK may be referred to as ASPK 0 for the first level of ASPs, ASPK 1 for the second level of ASPs, and ASPK N for the Nth level of ASPs.

In FIG. 2, simulation engine 200 has a parallel instantiation of K numbered DSCs 240, wherein each DSC 240 shares access to computational memory 210, supports an array of N ASPs, where N may or may not be the same for the different DSCs 240, and is controlled by bus interface controller 204. Bus interface controller 204 may comprise a simple state machine or a full blown CPU with its own operating system. DSCs 240 may comprise simple Direct Memory Access (DMA) devices or memory management functions (scatter/gather) needed to get I/O between data stream controllers. The ASPs may be configured to be small, specific, and all alike. The first level ASPs 220 and Nth level ASPs 224 in each ASP sub-array may be configured to contain special provisions for being at the ends of an array. The last level ASPs 224 may be configured to provide a “loop back” function so that inbound data stream 214 joins outbound data stream 216.

In FIG. 2, computational memory 210 may be configured for direct control by mapping controls and status into memory 104 or host memory. Computational memory 210 contains the current and next state vectors of the simulation cycle. Contiguous input data and contiguous output data may be sent to simulation engine 200 from storage device 106 or memory 104. Data and delimiters may be written in transactions 206 to computational memory 210 and may be managed by the application executing on computing system 100. During initialization, ASP instructions and variable assignment data images are written by transactions 206 into computational memory 210 for later transfer by DSCs 240.

Prior to a computational cycle, new inputs are written in transactions 206 to computational memory 210. The inputs may be from new real data or from a test fixture. After the computational cycle, newly computed values can be read out in transactions 206 to PCI interface controller 204 and then transactions 202 for final storage into host memory.

In some embodiments, DSCs 240 may be configured to trigger the next computation or respond, via an interrupt, to the completion of the last computation or the trigger of a breakpoint. In some embodiments, DSCs 240 may comprise a specialized DMA controller with provisions for inserting certain delimiters and detecting others of its own. It may be responsible for completing each step in the cycle but the cycle may be under control of the host software.

Outbound data stream 216 comprises a new initialization or new data for processing by one of the ASPs within an ASP array. During initialization, outbound data stream 216 also provides information on the ASP types that are a part of the overall simulation system. Inbound data stream 214 comprises computed data from the last computational cycle or status information. The inbound and outbound data streams connect all ASP modules whether they are all in the same chip or split up among many chips. The last physical ASP within an ASP sub-array contains un-terminated connections (indicated by dashed lines).

Host applications used to drive the architecture of FIG. 2 and controlling interactions of the various sequential bus and ASP components may be according to the teachings of U.S. patent application Ser. No. 11/303,817, entitled “A system and method for application specific array processing”, filed on Dec. 16, 2005, which is incorporated by reference herein.

In some embodiments, simulation state vectors can be completely contained in computational memory 210, can be formatted in a known form, distributed in a deterministic bus carrying outbound data stream 216 to a sea of logic processors comprising ASPs 220, 222, 224, and returned to computational memory 210 through the same or similar deterministic bus, carrying inbound data stream 214.

In some embodiments, the deterministic bus carrying inbound data stream 214 and outbound data stream 216 may be defined by having no ambiguity of content at any time or phase. Whether the bus carries parallel and/or serial content may be determined by properties like time slots, delimiters, pre-defined formats, fixed protocols, markers, flags, IDs and chip selects. Although there may be error detection/correction there need be no point-to-point control, handshaking, acknowledgements, retries nor collisions. An example of a “deterministic bus” is a microprocessor memory bus.

In some embodiments, a deterministic bus for inbound data stream 214 and outbound data stream 216 can be designed such that the actual sustainable data transfer rate may be nearly the full bandwidth of the physical bus itself. To create a simulation architecture that is limited only by the speed of RAM and bus construction, it is prudent to use the highest bandwidth forms of both.

Memory, bus and processing arrays illustrated in FIG. 2 may be designed as a high bandwidth data-flow such that a current state vector in computational memory 210 flows to the processor arrays and back as the next state vector to computational memory 210 in minimal time with little or no external software intervention. This reduces the simulation cycle time to a time it takes to read each element of current state once from computational memory 210, the computation of each next state element and the writing of each element of the next state to computational memory 210.

In many forms of deterministic buses, such as daisy-chained FIFOs, there is no theoretical limit to the number of processors in the array. So it is possible to turn all computationally limited simulations into I/O limited simulations by supplying enough processors in an array. In a practical system there is some balance struck between I/O and computation time.

In some embodiments, computational memory 210 and deterministic buses employed in connection with this disclosure may be according to the teachings of U.S. patent application Ser. No. 11/303,817, entitled “A system and method for application specific array processing”, filed on Dec. 16, 2005, which is incorporated by reference herein. Such embodiments may be more in line with a commodity PC plug-in peripheral card and may be more accessible to conventional simulation environments of the average engineer.

In some embodiments, the organization of memory, buses and processors illustrated in FIG. 2 may be dependent on the simulation goals of simulation environment designers. Specifically, one can design a system based on this disclosure where the speed of simulation is driven by the speed of memory and bus design. Since this usually has a cost and performance consequence depending on choices, the exact implementation depends on the designer's goals.

High end applications of this disclosure may involve massive parallel simulation of logic processors on deterministic buses that extend across multiple circuit boards contained on and interconnected by motherboards or backplanes. This market would involve simulation modeling of very large multiple chip systems such as an entire PC motherboard.

With the benefit of FIG. 1 and FIG. 2, it will be appreciated by those of skill in the art that the present disclosure provides technologies including devices, methods, and computer readable media relating to computing through unique concepts of processor design, the real time-dependent-behavior of combinatorial logic circuits in a manner that is compatible with a large scale network of BPUs and/or RTPUs. By “unique”, we refer to the modeling criteria for systems designed according to this disclosure, under which a multiplicity of actual implementations can be realized.

Most large scale models, whether represented in a high level construct or represented by gate level models, can be simulated with Boolean models and logic having the simple states of “0” (a logic low), a “1” (a logic high) or “unknown or undefined” (otherwise known as a simulation fault). Boolean models can propagate a fault (unknown input generates an unknown output) but they cannot generate a fault.

When a conceived model moves from a symbolic simulation to real gate synthesis (hardware implementation), timing delays with the logic can become critical and fault detection becomes important. Typically, 70 to 80% of any synthesized logic can be modeled with Boolean techniques but the remainder may require real time modeling.

Techniques disclosed herein provide a mixed-mode simulation environment that can be used to model a larger amount of synthesized logic than can be achieved with Boolean techniques alone, e.g., up to 95% or more of the synthesized logic in some models. The remaining 5% (plus or minus) of un-modeled synthesized logic may generally comprise the test fixture, model debugging, and real time simulation not compatible with a Boolean universe.

In some embodiments, FIG. 2 may comprise a mixed mode simulation network comprising BPUs and RTPUs, e.g., as illustrated in FIG. 3. The mixed mode simulation network 200 may comprise a computational memory 210 configured to store simulation state vectors; a data bus for transactions 212 coupled with the computational memory 210, data stream controllers 240 coupled with the data bus; and an array of processing units 220, 222, 224 coupled with the data stream controllers 240, the array of processing units comprising BPUs and RTPUs as illustrated in FIG. 3.

The mixed mode simulation network 200 may be adapted to send an input simulation state vector from the computational memory 210, through the data bus 212 and data stream controllers 240, to the array of processing units 220, 222, 224. Each processing unit in the array of processing units may be adapted to process a portion of the input simulation state vector to calculate a portion of an output simulation state vector. BPUs may be adapted to calculate portions of the output simulation state vector without accounting for delay times attributable to operation of a simulated system, while RTPUs are adapted to calculate portions of the output simulation state vector with accounting for delay times attributable to operation of the simulated system. The mixed mode simulation network 200 may be adapted to return calculated portions of the output simulation state vector from the array of processing units 220, 222, 224 through the data stream controllers 240 and data bus 212, and to combine the calculated portions of the output simulation state vector in the computational memory 210.

In some embodiments, the calculated portions of the output simulation state vector may comprise BCF and/or RTF vectors. The BPUs and RTPUs may be adapted to calculate the portions of the output simulation state vector using PTLCs and LETs, e.g., as illustrated in FIG. 3. The RTPUs may be adapted to account for delay times attributable to operation of the simulated system by looking up, in a delay table, delay times associated with transitions from components of the input simulation state vector, as also described in connection with FIG. 3.

FIG. 3 is a block diagram illustrating an example RTPU and its integration with a simulation network. FIG. 3 includes a RTPU 306 and a BPU 316 coupled by a bus 312. Bus 312 comprises a VSS bus.

RTPU 306 includes an execution unit 318, a memory component 304, and a read/write module 302. Execution unit 318 includes a PTLC 308 and a RTLU 310. Memory component 304 includes a dual port RAM with a port A coupled with execution unit 318 and a port B coupled with read/write module 302. Memory component 304 includes Assigned variables In/Out, LETs, Delay Tables, SW Instructions, Intermediate Variables, and Stack. Read/write module 302 comprises a VSS read/write module coupled with VSS bus 312. Read/write module 302 is adapted to extract input simulation state vector information from bus 312. Read/write module 302 is adapted to insert an output queue into a RAM FIFO component 314, and to write output simulation state vector information to bus 312.

BPU 316 includes an execution unit 320, a memory component 322, and a read/write module 323. Execution unit 320 includes a PTLC 321. Memory component 322 includes a dual port RAM with a port A coupled with execution unit 320 and a port B coupled with read/write module 323. Memory component 322 includes Assigned variables In/Out, LETs, SW Instructions, Intermediate Variables, and Stack. Read/write module 323 comprises a VSS read/write module coupled with VSS bus 312. Read/write module 323 is adapted to extract input simulation state vector information from bus 312. Read/write module 323 is adapted to write output simulation state vector information to bus 312.

A RTPU may be understood as one of many types of processors in a heterogeneous mixture of processors configured in an array such as illustrated in FIG. 2. In some cases the array may comprise a large scale array of distributed processing units with homogenous Input/Output (I/O) requirements. Though a simulation network can contain many different types of processors, scalability to large populations may be facilitated by uniformity of I/O and control. The RTPU of example embodiments described herein, in its preferred form, may comprise an I/O compatible with a BPU such as described in U.S. patent application Ser. No. 13/476,000, entitled “MACHINE TRANSPORT AND EXECUTION OF LOGIC SIMULATION”, filed on May 20, 2012, which is incorporated by reference herein. However, this does not represent the only embodiment of this invention, and other embodiments may be applied in the context of many different types of I/O.

In some embodiments, a RTPU may constitute an ASP and may require little or no functionality beyond the scope of real time logic simulation and I/O functions. Scalability to large populations may be facilitated by a small and efficient implementation of processor functionality that may be generally confined to a specific purpose and having a minimal silicon footprint.

The functionality of RTPUs adapted for use in the context of this disclosure may comprise taking faultless input to a logic model and through pre-defined properties of single propagation times, setting up and holding times of the receiving memory elements, and determining if there is a fault. RTPUs may also be adapted to provide results in a correct clock cycle for multi-clock pathways.

In some embodiments, a RTPU may include one or more non-Von Neumann machines to complete the computation, or optionally a Von Neumann processor with a specialized instruction set. Like the BPU, there are simpler machine constructions for evaluation of logic in real time than with brute force timing calculations. But the movement of data between machine and local memory may be by software instruction.

In logic simulation, distributed sources of delay along a logic path between real flip-flops in a real clock network can be modeled as idealized clocks, to idealized flip-flops and lumped delays. This holds true for example when the idealized receiving flip-flops maintain their real set-up and hold times. Under this model, Boolean and real time modeling can coexist with the RTPUs able to generate faults due to violations of either set-up or hold times.

In logic simulation, real-time models, though derived from SPICE simulations, may comprise approximations. These approximations may be lumped into cases of “worst-case fast”, “worst-case slow” and so on, and may be applied uniformly across the model.

This disclosure teaches, inter alia, a simulation machine capable of taking Boolean defined set of input bits, detecting transitions on the inputs, calculating and/or emulating the delays along the paths and determining if any timing violations result in a meta-stable state of the receiving flip-flops. This disclosure furthermore teaches delivering the result in the correct output clock cycle.

Some embodiments of this disclosure may use I/O and control protocols that are compatible with the BPU based network so that the RTPU can be combined with BPU and other processors in a distributed simulation network.

FIG. 3 shows a breakdown of two logic ASPs, the RTPU 306 and the BPU 316. RTPU 306 may expand the BPU 316 by the addition of, inter alia, a RTLU engine 310 adapted to use delay tables stored in RAM 304. The delay tables may contain, e.g., propagation times for a simulated system in terms of pre-defined units.

The PTLC 308 in RTPU 306 may be similar to PTLC 321 in the BPU 320, except in some embodiments, PTLC 308 in RTPU 306 may be smaller than PTLC 321. Real-time issues are generally more directed at synthetic primitives such as 2-input NAND gates of gate-arrays or 4 input look up table RAMs in FPGAs. A combinatorial tree of many physical gates may be represented by a set of small LETs and delay tables for each signal path.

The input vector format for input vectors extracted by read/write module 302 in RTPU 306 may be identical to the format used for Boolean ASPs, such as BPU 316, deployed in the same simulation network as RTPU 306, however, the output vector produced by RTPU 306 can be different from output vectors produced by BPU 316.

In a BCF output, the calculated, or look-up, time delays determine in which vector cycle the output changes, where each vector cycle represents one simulation clock cycle for the simulated system. A calculated delay that violates set-up or hold for the technology at a clock edge can generate an “unknown” as an output. The BCF output may generate the correct real-time response but the timing details are hidden from any other analysis.

To support a more conventional real-time simulation environment, RTPU 306 may be adapted to produce RTF output vectors, which RTF output vectors may be different than BCF input vectors. In any given simulation cycle, the RTF outputs may be combined with Boolean output by simulation host software to calculate the next state. Since timing information may be preserved for host software, more detailed analysis can be done at the penalty of a slower simulation cycle.

Since input and output are marked by delimiters and occur in separate phases of the simulation cycle, the mixture of BCF input, BCF output and RTF output are compatible with the VSS 312 bus behavior.

RTPU 306 may also contain RAM based FIFO 314 in the VSS Read/Write module 302. Unlike BCF outputs, RTF outputs of RTPU 306 may be marked with a time of change. After RTF outputs have been calculated by RTPU 306, they may be put in time order in an output queue with time markers or some other indexing technique. During an output phase, time marker delimiters on the VSS 312 bus may stimulate the VSS Read/Write module 302 to insert an output result into the VSS stream.

Before any RTF output is inserted, the FIFO 314 may have a depth of 1. Inserting 1 output result delays the VSS 312 input of the FIFO 314 by one entry and the FIFO 314 now has a depth of 2. For a RTPU 306 programmed to generate N RTF outputs, the FIFO 314 may have a maximum depth of N+1.

In some embodiments, depth control may be accomplished by the FIFO 314 being constructed of a circular buffer in ram with a separate input pointer and output pointer. When the FIFO 314 is empty, both pointer values may be identical. The “Depth” may be defined as the number values written to the FIFO 314 that have not yet been output.

In some embodiments, the combination of a small amount of sorting in the RTPU 306 and the ability to insert output into a VSS bus 312 stream in time order may eliminate the need to sort results in computational memory 210. This can simplify the merging of real time results into the next simulation state vector by host software.

In some embodiments, a RTPU such as 306 adapted for use in a simulation network such as simulation network 200 may comprise a read/write module 302 adapted to read input simulation state vectors for processing by the RTPU 306, and to write RTPU output simulation state vectors. RTPU 306 may comprise a memory component 304 adapted to store information as illustrated in FIG. 3, including, inter alia, input simulation state vectors for processing by the RTPU 306 as expressed by assigned variables, LETs; and a delay table. RTPU 306 may comprise an execution unit 318, comprising a PTLC adapted to calculate next simulation state vectors from input simulation state vectors and a LET, and a RTLU engine adapted to look up, in the delay table, delay times associated with transitions from components of input simulation state vectors to corresponding components of next simulation state vectors. RTPU 306 may be adapted calculate output simulation state vectors as next simulation state vectors minus transitions having delay times that exceed a clock cycle of a simulated system. In this context, therefore, the RTPU's “next simulation state vector” is a simulation state vector that is calculated in the RTPU 306 but need not be written to bus 312. Instead, it is the RTPU's “output simulation state vector” that is written to bus 312, for use in combining with other RTPU and/or BPU output vectors to generate the overall combined next or output simulation state vector for the simulated system—that is, the simulation state vector that is assembled in computational memory 210.

In some embodiments, read/write module 302 may comprise a VSS read/write module adapted to read input simulation state vectors by extracting input simulation state vectors from VSS bus 312, and adapted to write output simulation state vectors to the VSS bus 312. RTPU 306 may be adapted to use a RAM FIFO queue 314 in the read/write module 302 to calculate output simulation state vectors from next simulation state vectors and delay times. RTPU 306 may be adapted to apply transitions having delay times that exceed a clock cycle of a simulated system in one or more output simulation state vectors for subsequent clock cycles of the simulated system.

In some embodiments, the simulation network 200 may comprise a network of mixed BPUs and RTPUs. Output simulation state vectors may comprise BCF vectors and/or RTF vectors.

It will be appreciated with the benefit of this disclosure that methods according to FIG. 2 and FIG. 3 may include, e.g., methods for real-time simulation by a RTPU in a simulation network. Such methods may comprise, inter alia, reading an input simulation state vector, e.g., by read/write module 302 for processing by the RTPU 306; storing the input simulation state vector in a memory 304 for processing by the RTPU 306; calculating a next simulation state vector from the input simulation state vector, e.g., by execution unit 318 using PTLC 308; looking up delay times associated with transitions from components of the input simulation state vector to corresponding components of the next simulation state vector, e.g., by execution unit 318 using RTLU 310; calculating an output simulation state vector as the next simulation state vector minus transitions having delay times that exceed a clock cycle of a simulated system; e.g., through the use of output queue and RAM FIFO 314 in read/write module 302; and writing the output simulation state vector to a simulation network bus 312 for combination with one or more other simulation state vectors, e.g., by read/write module 302.

In some embodiments, reading the input simulation state vector may comprise reading from VSS bus 312, and writing the output simulation state vector to a simulation network bus may comprise writing the output simulation state vector to VSS bus 312. The input simulation state vector may be stored in a memory comprising a dual port RAM memory component 304. Calculating the next simulation state vector may comprise processing the stored input simulation state vector by a PTLC 308 using LET 310. Looking up delay times may comprise looking up the delay times in a delay table for the simulated system, which delay table may be stored in memory 304. Calculating the output simulation state vector may be accomplished by storing the next simulation state vector and delay times in RAM FIFO queue 314. RAM FIFO queue 314 may also apply transitions having delay times that exceed a clock cycle of the simulated system in one or more output simulation state vectors for subsequent clock cycles of the simulated system.

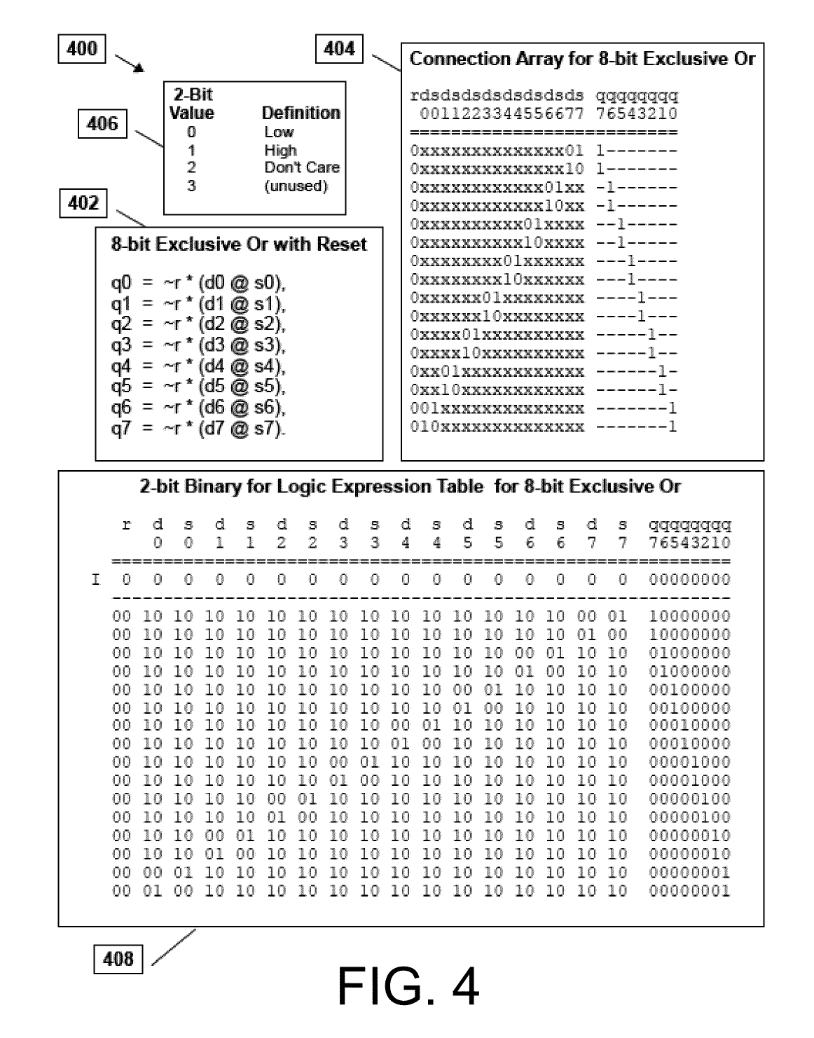

FIG. 4 shows an example of how combinatorial logic portions of a model may be supported by embodiments of this disclosure. A per bit expression for the combinatorial synthesis of an 8-bit “exclusive or with reset” is shown 402 in CAFE syntax with the symbols “*”, “+”, “˜” and “@” corresponding to the operators “and”, “or”, “not” and “Exclusive Or” respectively. The “d”, “r” and “s” bits would be from a portion of the current state vector and the “q” bits would be a portion of the new state vector.

CAFE (Connection Arrays From Equations, published by Donald P. Dietmeyer) was used to synthesize the connection array 404 which is a text notation for a Sum Of Products (SOP) form of equations. Although it looks like a truth table, the actual meaning of the entries is that on the right hand side, if there is a “1” in a column, then the product term on the left hand side applies to that output. So from this array q0=s0*˜d0*˜r+˜s0*d0*˜r.

For machine representation of the combinatorial we use a similar 2-bit format 406 as for the state vector for the symbolic values of “0” and “1” but also support a “don't care” value. With this definition the connection array can be converted to a binary LET 408 which can be use as a sequential look up table in machine execution.

The LET may include an inversion mask (row “I”) 408 which allows individual bits of the inputs or the outputs of the LET to be expressed using inverted logic. This is useful on the output side because in many logic expression the number of product terms may be smaller (fewer entries in the LET) if the output is solved for zeros instead of ones. For inputs or outputs it may be convenient to allow some or all logic in the vector to propagate in a state that matches the polarity of the memory elements.

For clarity of this document the column ordering generated by CAFE in the array 404 was maintained in the LET 408. The LET may be generated by the compiler where the “s” and “d” bits would not be interleave but may be in descending order.

Where the state vector resides in computational common memory and migrates to and from the ASP for processing into the next vector, the LET and any other methods of modeling logic structures is distributed and resides in the ASPs. At simulation initialization, the ASPs local RAM 304 are loaded with software and LETs and programmed with their assigned sections of the state vector.

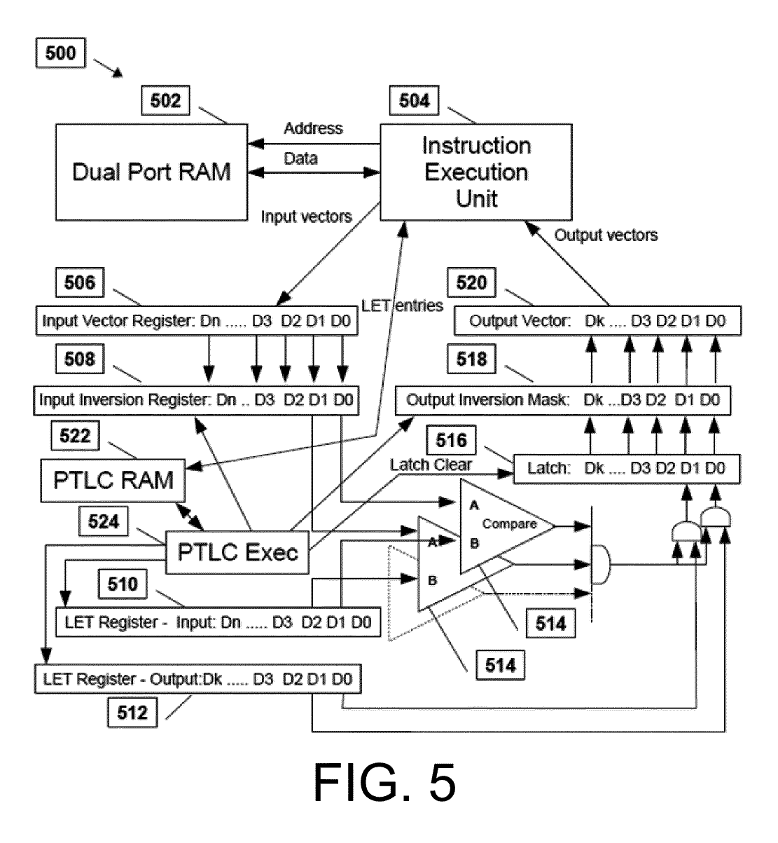

FIG. 5 shows one form of the BPU 316 side of the RTPU 306 for the purposes of diagramming the PTLC 308. This simplified diagram shows one port of the Dual Port RAM 304,502, the Execution Unit 504 (which has some not shown features common to ASPs), and the components of the PTLC.

The Instruction Execution Unit (IEU) 504 may comprise a basic processor configured to execute instructions from RAM like most other Von Neuman processors to move data between RAM and internal registers as well as performing the functions for which the ASP is designed. Though the sophistication levels of ASPs containing PTLC can vary considerably, usually with many additional non-PTLC components, only the PTLC components are shown here for clarity.

The diagram is symbolic in the sense that the actual bit representation is not shown. PLTCs can be built with 2-bit, 3-bit or larger representations of the state vector bits. The input inversion mask 508, the output inversion mask 518, and the LET outputs are all single bit per bit representations. The latch register is 2-bits per bit and the output vector may be equal to or larger than 2-bit per bit representation.

There is no analytical reason for the number of input bits (n) or output bits (k) that make up the PTLC. There are some practical physical limits. At the low end, when a PTLC is used in conjunction with a RTPU the simulated gate delays are for real gates of usually 5 or less inputs and single outputs so the PLTC bit width is likely to be small. For idealized RTL (Boolean) simulation, the physical size can be quite large and determined by other physical properties such as VSS bus size or RAM port width.

The IEU has an instruction set that can move whole n-bit words from RAM to the Input Vector Register 506 or from the Output Vector Register 520 back to RAM. Being that this is an efficient method, advanced compilers for use with embodiments of this disclosure may “pack” LETs along with packing composite vectors into whole words for fast execution. The IEU also contains lesser bit moves to the extent that vector registers can be loaded and unloaded with individual vector elements.

Typical operation may comprise: 1) One or more software instructions may be configured to load the input Vector register 506 from RAM 502. 2) One software instruction may be configured to execute a LET at a specific PTLC RAM address 522. 3) One or more software instructions may be configured to move the contents of the Output Vector Register 520 back into RAM 502.

The state machine within the PTLC Execution block 524 that executes the LET may: 1) Clear the status latch 516. 2) Load the input inversion register 508. 3) Load the output inversion register 518. 4) Sequentially load each LET entry into the Input register 510 and output register 512 until the list is exhausted.

Each 2-bit element of the status latch 516 is initialized to an “unmatched” status. The comparators 514 on a symbolic bit-by-bit basis tests the input vector to see if it matches the LET input register. Three possible results include “unmatched”, “matched” or “undefined”. The “don't care” LET input matches any possible input including “undefined”. All of the comparator outputs may be “anded” so that all of the comparators may show a “matched” condition for there to be a product term match.

If there is a product term match, the LET output register 512 may enable routing the status of the match to the latch 516. It is referred to as a “latch” since once set to a status of “matched” it may not be cleared till the next new LET evaluation. If the latch is set to “undefined” it may retain this value as well unless overridden by a matched condition.

While the LET is being evaluated and the latch 516 is taking on its final values, the Output Inversion Mask may be applied and a new value the Output Vector Register 620 may be created.

In embodiments that are software based, the IEU 504 can be programmed to handle multiple LETs and multiple sets of input vectors. It may be limited by RAM 502 capacity and little or nothing else. Furthermore RAM 502 can be utilized by IEU software to support intermediate values. This is useful for computation of terms common to more than one LET as input. An example of this is “wide decoding”. The width of the PTLC can be much smaller than the width of a word to be evaluated. The word is evaluated in more than one step in PTLC sized portions with results being passed on to the next step.

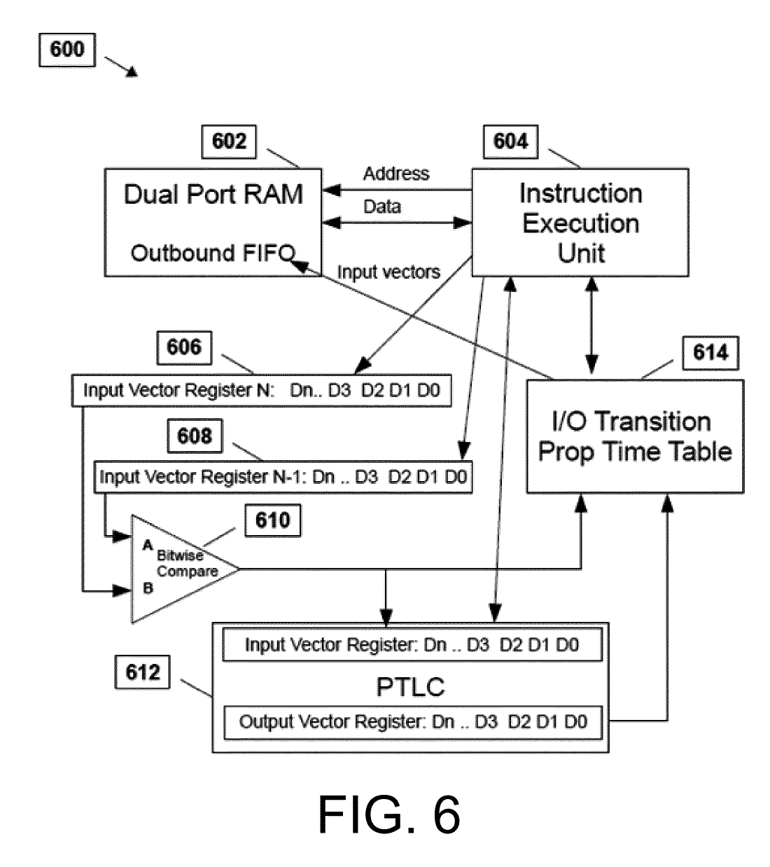

FIG. 6 shows a symbolic block diagram of the RTLU 310 side of the RTPU 306. The dual port RAM 602, 502, 304 and the IEU 604,504, 318 may be embodied in a same physical entity in some embodiments, but could also be broken up (i.e. pipelined) into separate components in other embodiments.

In Boolean evaluation of logic for cycle based simulation, it may be assumed that logic will resolve itself in a single simulation cycle so the previous state of bits is not relevant. The whole current vector, or substantially the whole current vector, may be used to compute the next vector and all outputs, or substantially all outputs, may be valid in a single cycle.

In real time computation, knowledge of the previous states may be used in evaluation of the state of change for the output. In the RTPU, input vectors may be double-buffered in RAM 602 such that an input vector for the current vector N 606 can be compared with the same vector from the previous input vector N−1 608.

Through bit comparison 610, the RTLU process 600 can determine if the bit change has an impact on the output through the PTLC 612, and know when to schedule the change from the Propagation Time Table (PTT) 614, and to apply the cumulative output to the output FIFO in RAM 602.

The RTLU process 600 can be done in software with a conventional processor, as could the PTLC. The ASPs used in the BPU for LET evaluation are may comprise efficient implementations, and may have data move instructions similar to other processors. Similarly, the process of determining a bit-by-bit change and propagation schedule can have a multiplicity of embodiments with many of them being unique, and may have similar data move instructions

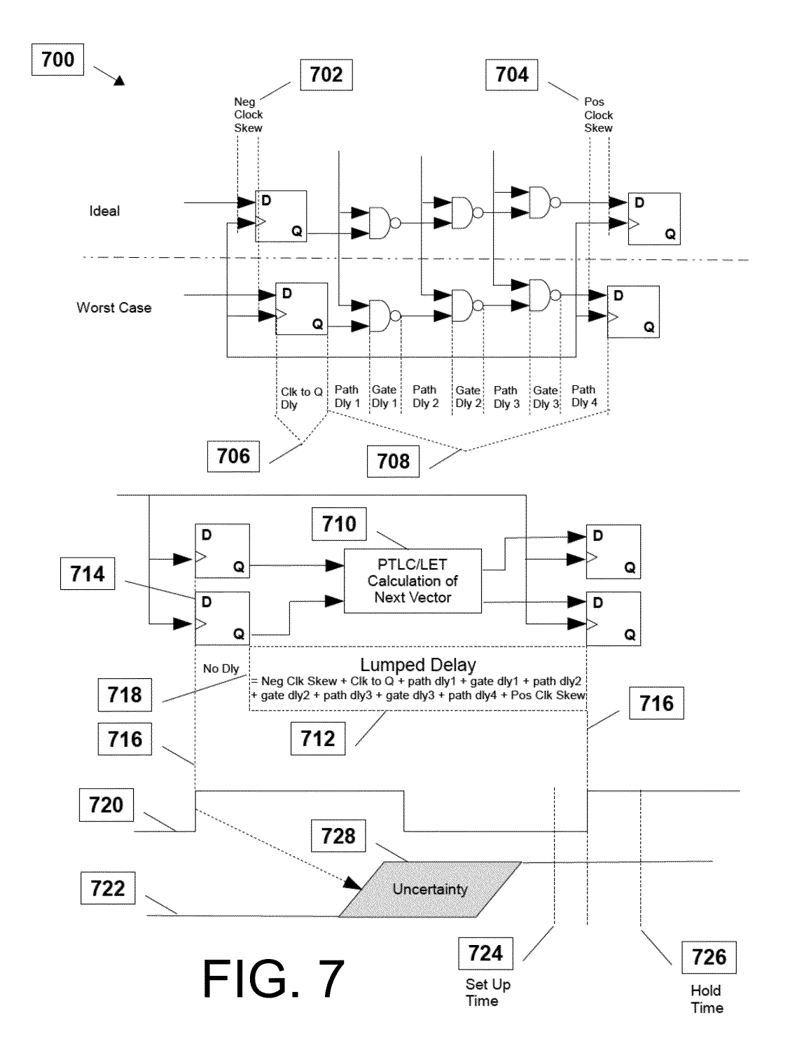

FIG. 7 is a symbolic diagram to show how distributed delays can be dealt with as a lumped delay model. This concept is not exclusive to this invention but is provided for clarity on how this invention can be integrated into a larger Boolean context by exposing the boundaries of idealized and real modeling behavior.

In a typical logic circuit, real delays that need to be modeled come from a variety different sources and causes. Clock skew is a harsh reality to the logic designer that results in the clock edge not arriving to all the flip-flops in the system at exactly the same time. FIG. 7 shows a worst case scenario where the source flip-flop is getting a late clock “Neg Clock Skew” 702 and the destination flip-flop is getting an early clock “Pos Clock Skew” 704, both of which artificially shorten the clock period for logic to resolve to the next state.

Gate delays begin with the “Clk to Q” delay 706 and the cumulative gate delays 708 that exist along the logic path. These delays are usually uniform across the model if they exist in an ASIC or an FPGA and may take on various types of worst-case values for case based simulations. The path delays 708, on the other hand, may be unique to the routing resources used in any design.

In the RTPU model we assume that flip-flops and clock networks are idealized in that the clock network has no skew 716 and the “Clk to Q” delay of the flip-flops is zero 718. What is retained from the real flip-flop model is the “Set Up Time” 724 and “Hold Time” 726.

The RTLU function of the RTPU may use the cumulative real delays 712 to determine if the logic transition affecting an output as determined by the PTLC will arrive at the destination flip-flop prior to the “Set up” 724, OR if the transition will not occur until after the “Hold Time” 726. These consequences may comprise the only value two consequences of a valid output, with the latter being scheduled for a change in a later clock cycle.

The delay values pre-calculated by host application software are not necessarily in any particular units of time. Time calculations carry more overhead and require unnecessary resources in the processing engines. In some simulation environments there is a time resolution parameter such that if one is looking a 1 nanosecond event, the computational limit might be set to 10 picoseconds. In the RTLU, the resolution may be set by the number of subdivisions of a clock period. If a clock period (simulation cycle) represented 10 nanoseconds, a mere 10-bit number can specify a delay with 10 picosecond resolution. Clock period relative delays allow for simple and fast determination of a real time response with no meaningful loss of resolution.

Since many factors (temperature, silicon process, supply voltage, etc.) influence when a transition occurs, there may be a region of “Uncertainty” 728, that goes with real analysis. Because real time behavior is more computationally intensive (10× slower or more) in the industry, paths with short delays are usually sloughed off to Boolean or cycle-based simulation and the more questionable paths are done in real time. Due to the architectural similarity with the BPU, the RTPU should enjoy the benefits of application specific implementation and the economy of large scale arrays so there may be less of a penalty for using the RTPU in a more homogenous network.

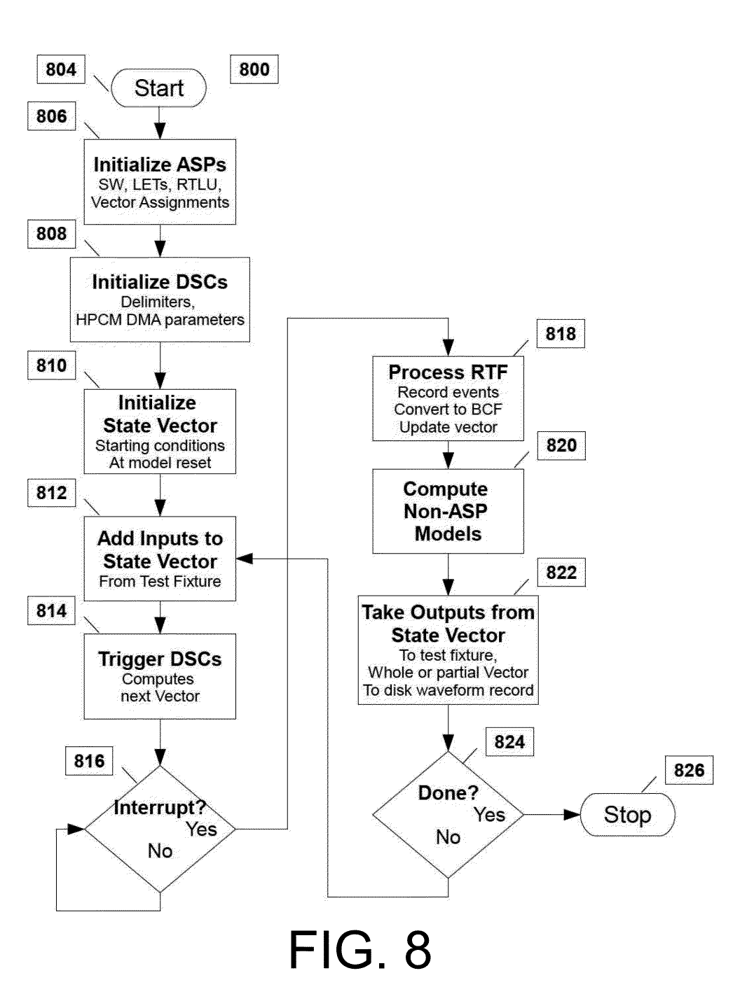

FIG. 8 is a flow diagram illustrating an example method configured to simulate a logic cycle from a host software perspective, arranged in accordance with at least some embodiments of the present disclosure. The example flow diagram may include one or more operations/modules as illustrated by blocks 804-826, which represent operations as may be performed in a method, functional modules in a computing device configured to perform the method 800, and/or instructions as may be recorded on a computer readable medium. The illustrated blocks, 804-826 may be arranged to provide functional operations of “Start” at block 804, “Initialize ASPs” at block 806, “Initialize DSCs” at block 808, “Initialize State Vector” at block 810, “Add Inputs to State Vector” at block 812, “Trigger DSCs” at block 814, “Interrupt?” at decision block 816, “Process RTF” at block 818, “Compute Non-ASP Models” at block 820, “Take Outputs from State Vector” at block 822, “Done?” at decision block 824, and “Stop” at block 826.

In FIG. 8, blocks 804-826 are illustrated as including blocks being performed sequentially, e.g., with block 804 first and block 826 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 8 illustrates an example method by which the computing device configured to perform method 800 may execute logic simulation, data distribution, and distributed execution, that enable the design and execution of machines used in logic simulation. The steps in FIG. 8 may implement a mixed mode simulation of real-time and Boolean modeling on a cycle-by-cycle basis. Because a focus of this disclosure is on state vector computing, details of the simulation environment (test fixtures, user inputs, display outputs, etc.) will not be presented. The scope of FIG. 8 is oriented toward the scenario of a PCI plug-in simulation engine as presented in other figures, but this strategy is extensible to more complex hardware architectures such as blades systems and large customized HPC solutions.

In a “Start” block 804, the computing device configured to perform method 800 may be configured to begin initialization steps by the host software in blocks 806, 808, and 810. The order of these three blocks may depend on the exact machine architecture and may be rearranged. Because ASP components can be implemented in both FPGAs and ASICs, initialization may involve steps not shown to program FPGAs to specific circuit designs and/or polling ASICs for their ASP type content.

In an “Initialize ASPs” block 806, the computing device configured to perform method 800 may be configured to partition the physical model among the ASPs available by loading software, LETs, RTLU, and whatever else is needed to make up what is known in the industry as one or more “instantiations” of a logic model. The “soft” portion of the instantiation is the LETs, delay tables, ASP software, etc. that make up re-usable logic structure. A “hard” instantiation is the combination of the soft instantiation with an assigned portion of the state vector that is used by the soft instantiation. Replication of N modules in a design is the processing of N portions of the state vector by same soft instantiation.

In an “Initialize DSCs” block 808, the computing device configured to perform method 800 may be configured to set up Direct Memory Access (DMA)-like streams of vectors in DSCs 240 to and from computational memory 210. Block 808 may be executed in conjunction with block 810.

In an “Initialize State Vector” block 810, the computing device configured to perform method 800 may be configured to reset initial state vector values. Block 810 may be executed in conjunction with block 808 because there is a partitioning of the state vector among the ASPs on any given DSC and among the multiple DSC and their ASP arrays that may be a part of the system. Partition affects the organization of the vector elements in computational memory 210 where the initial values of these elements reflect the state of the model at the beginning of the complete simulation (an initial point where the global reset is active).

In an “Add Inputs to State Vector” block 812, the computing device configured to perform method 800 may be configured to apply inputs from a test fixture. The input may be from specifically written vectors in whatever available HDL (High-level Description Language), from C or other language interfaces, data from files, or some real-world stimulus. Whatever the source, inputs may be converted into vector elements in a format detailed in FIG. 4 as one or more complete or part of one or more composite vectors. Block 812 starts the simulation cycle, which represents the computation of the next state.

In a “Trigger DSCs” block 814, the computing device configured to perform method 800 may be configured to trigger the DSCs 240. Triggering the DSCs 240 results in DSCs 240 sending out the complete current state vector from computational memory 210 to the ASP array where it gets processed. DSCs 240 receive and send forward to computational memory 210 the processed state vector (the nearly complete next state vector).

In an “Interrupt?” decision block 816, the computing device configured to perform method 800 may be configured to check for a host interrupt. When the current state vector has been fully processed into the next state vector, the done delimiter generates a host interrupt and triggers an instruction to load the next state vector into computational memory 210. When computational memory 210 has received the next state vector, the host software moves on to the next block.

In a “Process RTF” block 818, the computing device configured to perform method 800 may be configured to complete the processing of the new state vector by integrating real-time data in RTF form into BCF form and computing models not covered in the next block. As described herein, RTF form real-time information is more for the use of additional analysis and diagnostics, and becomes, in addition to a source of next vector information, a portion of the state vector outputs 822 so that the real time of state transition can be reported to the simulation environment or recorded.

In a “Compute Non-ASP Models” block 820, the computing device configured to perform method 800 may be configured to complete the processing of the new state vector by computing non-ASP models and models not covered in block 818.

In a “Take Outputs from State Vector” block 822, the computing device configured to perform method 800 may be configured to transmit and/or record a state vector output or portions thereof. In simulation environments, state vector output produced at block 822 may be used for a variety of purposes such as waveform displays, state recording to disk, monitoring of key variables and the control and management of breakpoints. After a simulation computational cycle, host software examines vector locations in computational memory 210 to extract whatever information may be necessary.

In a “Done?” decision block 824, the computing device configured to perform method 800 may be configured to detect when “done” conditions are met in the host test fixture software. “Done” may be indicated by a breakpoint condition or the completion of the number of simulation cycles requested by the simulation environment. If we are “done,” the host software may finish up with simulation post processing to complete session displays and controls in the simulation environment as presented to the user. If we are not “done,” the host software may advance minimal feedback to the user and we start a new cycle with new vector inputs by repeating blocks 812 through 824 until “done” conditions are met.

In some embodiments, the host software management of breakpoints and state vector extraction may become a control bottleneck to overall performance. It is likely that breakpoint ASPs and high-speed data channels from computational memory to mass storage media and other mechanism could be deployed for better vector I/O performance.

In a “Stop” block 826, the computing device configured to perform method 800 may be configured stop running a simulation.

In some embodiments, the simulation engine may execute “vector patching,” a processing type where computed vector components are relocated or replicated to facilitate the mapping of the inputs and outputs of various pieces of the simulation model. Patching could be done by host software (for example—in the Add Inputs step 812), DSC-like machines operating from computational memory, or special ASPs. Other processing may comprise part of the simulation system that are not illustrated in the flow chart or discussed herein.

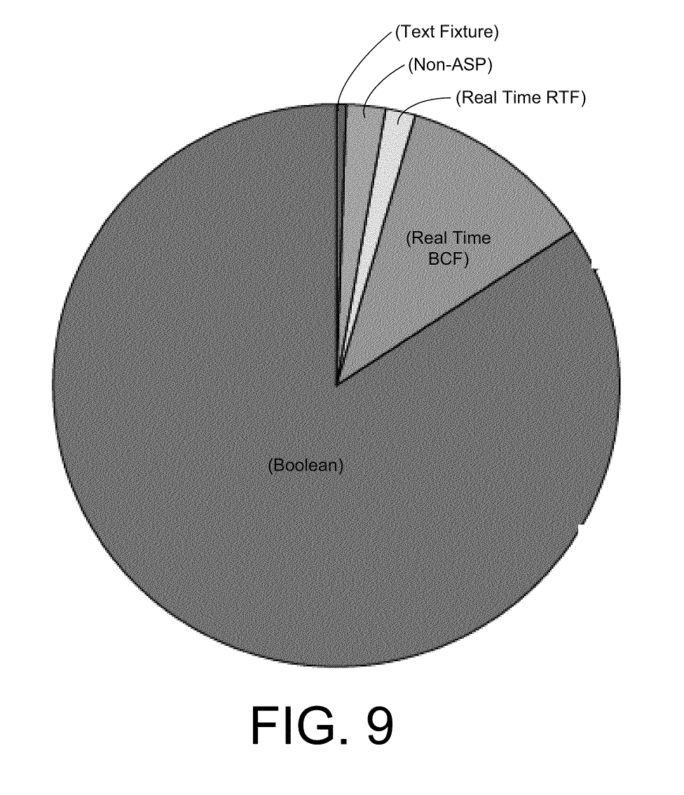

FIG. 9 is a pie chart of a mixed mode model, arranged in accordance with at least some embodiments of the present disclosure. FIG. 9 represents the computational work involved in each simulation cycle of an embodiment of the computing device configured to perform method 800 in FIG. 8. In FIG. 9, the computational work comprises Boolean, Real Time BCF, Real Time RTF, Non-ASP, and Test Fixture. There are no restrictions on the sophistication of an ASP and many other types of processors possible for accelerated simulation. For models not covered by ASPs discussed herein, assume the models to be supplied by host software and are denoted as Non-ASP portions of the model in FIG. 9.

At the boundaries of the model, there are test fixture interfaces which make up the I/O boundaries for the application of stimulus and the gathering of results.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Designing the circuitry and/or writing the code for the software and or firmware would be within the skill of one of skill in the art in light of this disclosure.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A Real Time Processing Unit (RTPU) adapted for use in a simulation network, comprising:
a read/write module adapted to read input simulation state vectors for processing by the RTPU, and to write RTPU output simulation state vectors;
one or more memory components adapted to store:
input simulation state vectors for processing by the RTPU;
a Logic Expression Table (LET); and
a delay table; and
an execution unit, comprising:
a Product Term Latching Comparator (PTLC) adapted to calculate next simulation state vectors from input simulation state vectors and the LET; and
a Real Time Look Up (RTLU) engine adapted to look up, in the delay table, delay times associated with transitions from components of input simulation state vectors to corresponding components of next simulation state vectors;
wherein the RTPU is adapted calculate output simulation state vectors as next simulation state vectors minus transitions having delay times that exceed a clock cycle of a simulated system.

2. The RTPU of claim 1, wherein the read/write module comprises a Vector State Stream (VSS) read/write module adapted to read input simulation state vectors by extracting input simulation state vectors from a VSS bus, and adapted to write output simulation state vectors to the VSS bus.

3. The RTPU of claim 1, wherein the one or more memory components comprise a dual port Random Access Memory (RAM) component.

4. The RTPU of claim 1, wherein the RTPU is adapted to use a RAM First In First Out (FIFO) queue in the read/write module to calculate output simulation state vectors from next simulation state vectors and delay times.

5. The RTPU of claim 1, wherein the RTPU is adapted to apply transitions having delay times that exceed a clock cycle of a simulated system in one or more output simulation state vectors for subsequent clock cycles of the simulated system.

6. The RTPU of claim 1, wherein the simulation network comprises a network of mixed Boolean Processing Units (BPUs) and RTPUs.

7. The RTPU of claim 1, wherein the output simulation state vectors comprise one or more of Boolean Compatible Format (BCF) vectors or Real Time Format (RTF) vectors.

8. A method for real-time simulation by a Real Time Processing Unit (RTPU) in a simulation network, comprising:
reading an input simulation state vector for processing by the RTPU;
storing the input simulation state vector in a memory for processing by the RTPU;
calculating a next simulation state vector from the input simulation state vector;
looking up delay times associated with transitions from components of the input simulation state vector to corresponding components of the next simulation state vector;
calculating an output simulation state vector as the next simulation state vector minus transitions having delay times that exceed a clock cycle of a simulated system; and
writing the output simulation state vector to a simulation network bus for combination with one or more other simulation state vectors.

9. The method of claim 8, wherein calculating the next simulation state vector comprises processing the input simulation state vector by a Product Term Latching Comparator (PTLC) using a Logic Expression Table (LET).

10. The method of claim 8, wherein looking up delay times comprises looking up the delay times in a delay table for the simulated system.

11. The method of claim 8, wherein reading the input simulation state vector comprises reading from a Vector State Stream (VSS) bus, and wherein writing the output simulation state vector to a simulation network bus comprising writing the output simulation state vector to the VSS bus.

12. The method of claim 8, wherein the input simulation state vector is stored in a memory comprising a dual port Random Access Memory (RAM) memory component.

13. The method of claim 8, wherein calculating the output simulation state vector comprises storing the next simulation state vector and delay times in a RAM First In First Out (FIFO) queue.

14. The method of claim 8, further comprising applying transitions having delay times that exceed a clock cycle of the simulated system in one or more output simulation state vectors for subsequent clock cycles of the simulated system.

15. The method of claim 8, wherein the simulation network comprises a network of mixed Boolean Processing Units (BPUs) and RTPUs, and further comprising combining the output simulation state vector with output simulation state vectors from the network of mixed BPUs and RTPUs.

16. The method of claim 8, wherein the output simulation state vector comprises one or more of a Boolean Compatible Format (BCF) vector or a Real Time Format (RTF) vector.

17. A mixed mode simulation network comprising Boolean Processing Units (BPUs) and Real Time Processing Unit (RTPUs), the mixed mode simulation network comprising:
at least one computational memory configured to store simulation state vectors;
at least one data bus coupled with the computational memory;
at least one data stream controller coupled with the data bus; and
at least one array of processing units coupled with the data stream controller, the array of processing units comprising BPUs and RTPUs;
wherein the mixed mode simulation network is adapted to send an input simulation state vector from the computational memory, through the data bus and data stream controller, to the array of processing units;
wherein each processing unit in the array of processing units is adapted to process a portion of the input simulation state vector to calculate a portion of an output simulation state vector;
wherein the BPUs are adapted to calculate portions of the output simulation state vector without accounting for delay times attributable to operation of a simulated system;
wherein the RTPUs are adapted to calculate portions of the output simulation state vector with accounting for delay times attributable to operation of the simulated system; and
wherein the mixed mode simulation network is adapted to return calculated portions of the output simulation state vector from the array of processing units through the data stream controller and data bus, and to combine the calculated portions of the output simulation state vector in the computational memory.

18. The mixed mode simulation network of claim 17, wherein the calculated portions of the output simulation state vector are in one or more of a Boolean Compatible Format (BCF) or a Real Time Format (RTF).

19. The mixed mode simulation network of claim 17, wherein the BPUs and RTPUs are adapted to calculate the portions of the output simulation state vector using Product Term Latching Comparators (PTLCs) and Logic Expression Tables (LETs).

20. The mixed mode simulation network of claim 17, wherein the RTPUs are adapted to account for delay times attributable to operation of the simulated system by looking up, in a delay table, delay times associated with transitions from components of the input simulation state vector.
